(19) United States
(12) Patent Application Publication
(10) Pub. No.: US 2009/0033882 A1
(43) Pub. Date: Feb. 5, 2009

(54) Projection device

(76) Inventor: Mark C. Solomon, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/888,525

(22) Filed: Jul. 31, 2007

(51) Int. Cl. G03B 21/20; G03B 21/14

(52) U.S. Cl. 353/85; 353/101

(57) ABSTRACT

A projection device comprises a first lens assembly movably disposed within a housing and configured to automatically activate the projection device to display an image in response to the first lens assembly being moved to an extended position relative to a second lens assembly.

### BACKGROUND

Micro projection devices typically require different lenses of the device to be a specified distance apart from each other in order to properly project and/or magnify an image transmitted by a wired and/or wireless electronic device. Because of the compact nature of the micro projection device, the layout and/or orientation of various components in the micro projection device limits the size and/or placement of the various lenses and other components in the micro projection device.

### BRIEF DESCRIPTION OF THE DRAWINGS

FIG. 1 is a perspective view of an embodiment of a projection device; and

FIGS. 2A and 2B are cross-sectional views of the projection device taken along line 2-2 of FIG. 1.

### DETAILED DESCRIPTION OF THE DRAWINGS

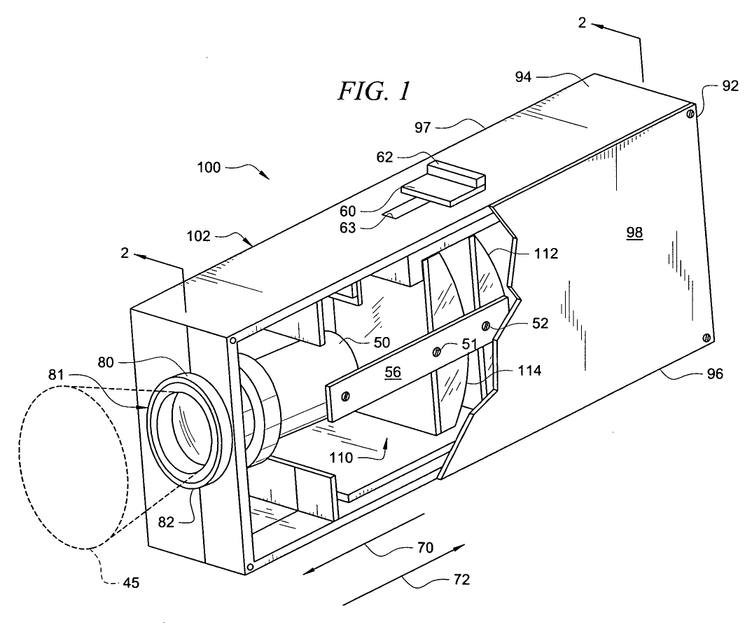

FIG. 1 is a perspective view of an embodiment of a projection device 100. Projection device 100 is a video projecting electronic device configured to display a magnified image transmitted by a wired and/or wireless electronic device. Projection device 100 comprises a housing 102 configured to house at least one component of projection device 100. In the illustrated embodiment, housing 102 is configured in a rectangular shape; however, it should be understood that housing 102 may be otherwise shaped (e.g., cylindrical shape, hexagonal shape, etc.). Housing 102 comprises a front wall 90, a rear wall 92, a top wall 94, a bottom wall 96, and side walls 97 and 98.

In the illustrated embodiment, a slider 60 is disposed on an external surface of top wall 94 of housing 102. An “external surface” as used herein is an outside and/or exterior surface of a wall of housing 102. It should be understood, however, that slider 60 can be otherwise disposed on housing 102 (e.g., bottom wall 96, side wall 97, side wall 98, etc.). Slider 60 is slidably coupled to housing 102 to enable a user of projection device 100 to slide slider 60 relative to housing 102 in a forward direction 70 and a rearward direction 72 relative to housing 102. For example, in the illustrated embodiment, slider 60 comprises an upwardly extending tab 62, and slider 60 extends downwardly into an interior portion of housing 102. In FIG. 1, slider 60 is disposed within a track 64 to enable movement of slider in the directions 70 and 72 relative to housing 102. However, it should be understood that other types of mechanical and/or electrical actuation mechanisms may be used with projection device 100 (e.g., a power button, a motorized mechanism, a biased mechanism, etc.). As will be described in further detail below, movement of slider 60 causes corresponding movement of a lens assembly 110 disposed within housing 102 to automatically activate/deactivate and/or turn “on” and “off” projection device 100.

In the embodiment illustrated in FIG. 1, projection device 100 comprises lens assembly 110 coupled to slider 60 and movably disposed within housing 102. Lens assembly 110 comprises one or more lenses used to magnify and/or otherwise manipulate an image being projected by projection device 100 (e.g., image 45) transmitted by an electronic device wired and/or wirelessly coupled to projection device 100. In the illustrated embodiment, lens assembly 110 comprises a lens barrel 50, lenses 112 and 114, and a connector 56 coupling lenses 112 and 114 and lens barrel 50 together. In the illustrated embodiment, fasteners 51 and 52 are used to couple lenses 112 and 114 to connector 56. It should be understood, however, that connector 56 can be any type of coupling device (e.g., a linkage, a brace, a stiffener, etc.) comprising any type of material (e.g., plastic, metal, any combination thereof, etc.). Fasteners 51 and 52 can be any type of securing device (e.g., a screw, a bolt, adhesive, etc.) configured to couple lenses 112 and 114 to connector 56. It should be understood that lenses 112 and 114 may be disposed in and/or otherwise supported by one or more support elements (e.g., disposed about a periphery of lenses 112 and 114) such that connector 56 is connected to such support elements (as opposed to being connected directly to lens 112 and/or 114). In the illustrated embodiment, lenses 112 and 114 are piano convex lenses oriented in the same direction (e.g., both curved portions of lenses 112 and 114 face the internal surface of rear wall 92) and may have the same or different dimensions. However, it should be understood that lenses 112 and 114 may be any type of lens (e.g., biconvex, convex-concave, meniscus, plano-concave, biconcave, etc.) having any type of shape and/or imaging characteristics. It should be understood that lens assembly 110 may comprise a greater or fewer quantity of lenses.

In the embodiment illustrated in FIG. 1, housing 102 comprises an opening 80 disposed in front wall 90 through which a portion 81 of lens barrel 50 extends and retracts. For example, in the illustrated embodiment, lens barrel 50 comprises a focusing element 82 that extends at least partially outward of housing 102 when lens barrel 50 is disposed in an extended position relative to housing 102, thereby facilitating user access thereto. In FIG. 1, lens assembly 110 is illustrated in at least a partially extended position relative to housing 102, thereby automatically turning projection device 100 “on.” It should be understood that in a retracted position, portion 81 of lens barrel 50 may be disposed flush (flush or substantially flush) with an exterior surface of wall 90 and/or partially recessed relative to the exterior surface of wall 90.

In operation, when a force is applied to tab 62 of slider 60 in direction 70, lens assembly 110 moves in direction 70 to an extended position relative to housing 102. In response to lens assembly 110 moving a predetermined distance in the direction 70 toward an extended position relative to housing 102, projection device 100 automatically turns “on” and/or enables a current to flow to a light and/or lamp located in projection device 100, thereby causing image 45 to be projected from projection device 100. When a user applies a force to tab 62 of slider 60 in direction 72, lens assembly 110 moves in direction 72 toward a non-extended or retracted position relative to housing 102. In response to lens assembly 110 moving a predetermined distance in the direction 72, projection device 100 automatically turns “off.”

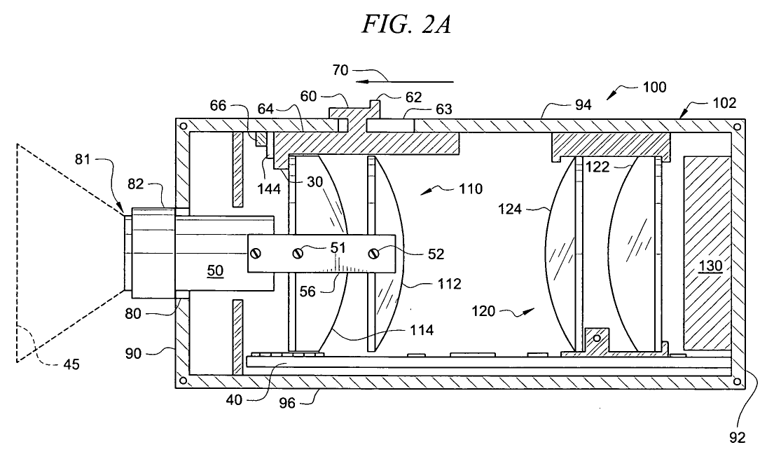

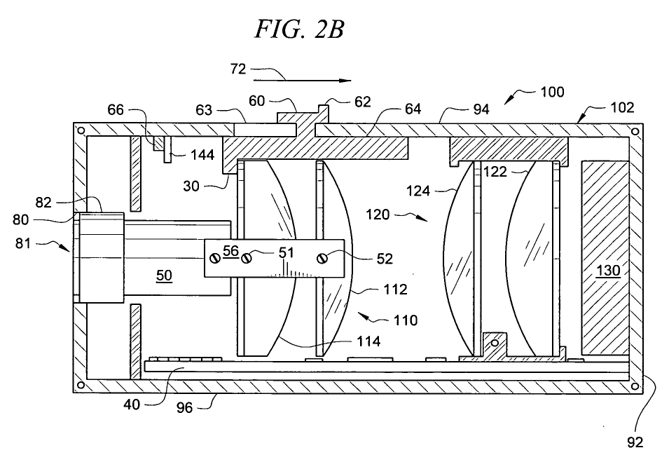

FIGS. 2A and 2B are cross-sectional views of projection device 100 taken along line 2-2 of FIG. 1 with lens assembly 110 in an extended and a retracted position, respectively, relative to housing 102. In some embodiments, when lens assembly 110 is in an extended position, projection device 100 is “on,” and when lens assembly 110 is in a retracted position, projection device 100 is “off.” In FIGS. 2A and 2B, slider 60 comprises an engagement member 64 disposed within housing 102 and slidably coupled to an interior surface of top wall 64. In the illustrated embodiment, engagement member 64 is coupled to lens assembly 110 and enables lens assembly 110 to move in directions 70 and 72 in response to corresponding movement of slider 60 in directions 70 and 72.

In FIGS. 2A and 2B, engagement member 64 comprises an extension 30 coupled to at least a portion of lens assembly 110. For example, in some embodiments, extension 30 is coupled to a forwardly-facing portion of lens 114. However, it should be understood that engagement member 64 may be coupled to other and/or additional portions of lens assembly 110 (e.g., engagement member 64 having multiple extensions or ribs having lenses 112 and 114 seated between respective ribs, etc.). It should also be understood that engagement member 64 may engage other non-lens portions of lens assembly 110 (e.g., a housing structure or other support member associated with lens 112 and/or 114). Thus, in operation, movement of slider 60 and corresponding engagement member 64 in directions 70 and 72 causes corresponding movement of lens assembly 110 in the directions 70 and 72.

In FIGS. 2A and 2B, the interior surface of top wall 94 comprises a stop 66 configured to limit the movement of engagement member 64 in direction 70. Stop 66 can be any type of limiting component (e.g., an extended portion of housing 102, a rubber grommet, etc.). In the illustrated embodiment, projection device 100 also comprises a sensor 144 coupled to stop 66 and configured to detect the position of lens assembly 110 within housing 102 (e.g., detect engagement/disengagement of extension 30 engagement member 64 with sensor 144). However, it should be understood that stop 66 and/or sensor 144 may be otherwise located in housing 102. Further, it should be understood that other devices and/or elements may be used to limit the length of travel of lens assembly 110 (e.g., the length and endpoints of track 63).

In the embodiment illustrated in FIGS. 2A and 2B, projection device 100 also comprises a light 130, a lens assembly 120, and a printed circuit board 140. Light 130 is an illumination device used to emanate a light wave through lens assembly 120 and lens assembly 110 to enable projection and/or display of image 45 (FIGS. 1 and 2A). In the illustrated embodiment, light 130 is disposed along an interior surface of rear wall 92. However, it should be understood that light 130 may be otherwise positioned (e.g., on an interior surface of bottom wall 96, etc.) and configured to emanate a light wave in an angular direction (e.g., using one or more mirrors to reflect and/or bend the light wave to enable projection of image 45). In the illustrated embodiment, lens assembly 120 is disposed toward a rearward portion of housing 102 and comprises plano-concave lenses 122 and 124. In the illustrated embodiment, lenses 122 and 124 are oriented in an opposite direction than lenses 112 and 114 (e.g., the curved portion of lenses 122 and 124 face the interior of front wall 90). However, it should be understood that lens assembly 120 may comprise more or fewer lenses and may be otherwise positioned and/or shaped. In the embodiment illustrated in FIGS. 2A and 2B, lens assembly 120 is disposed in a fixed position within housing 102 such that lens assembly 110 moves relative to a stationary lens assembly 120. However, it should be understood that in some embodiments, the particular lens assembly 110 or 120 that is configured to be movable may be varied.

In FIGS. 2A and 2B, printed circuit board 140 is disposed along an interior surface of bottom wall 96 and is configured to enable projection device 100 to turn “on” and “off” (e.g., light 130 being turned “on” and “off”) in response to lens assembly 110 being disposed in a particular location relative to housing 102 and/or based on a position of lens assembly 110 relative to lens assembly 120. It should be understood that printed circuit board 140 may be otherwise coupled to various components (e.g., via cable, etc.) in projection device 100 to enable an electrical current and/or electronic communications to be transmitted between the various components in projection device 100. Printed circuit board 140 is electrically coupled to sensor 144 and is configured to turn “on” light 130 in response to sensor 144 transmitting a signal indicating that that extension 30 is in contact with sensor 144.

Thus, referring to FIG. 2A, in operation, in response to lens assembly 110 moving in direction 70, engagement member 64 causes lens assembly 110 to move in direction 70 relative to stationary lens assembly 122. Continued movement of lens assembly 110 in the direction 70 causes extension 30 to contact sensor 144 (and stop 44 ceases further movement of engagement member 64 in the direction 70), thereby causing sensor 144 to transmit a current and/or signal to printed circuit board 140 and causing light 130 to turn on. Light 130 then emits a light wave through lens assembly 120 and lens assembly 110 to project image 45.

Referring to FIG. 2B, projection device 100 is in an “off” and/or retracted position, thereby having no image 45 (FIGS. 1 and 2A) being projected by projection device 100. In the illustrated embodiment, lens barrel 50 is in a retracted position relative to housing 102. In operation, to turn projection device “off,” slider 60 is moved in direction 72. In response to movement of slider 60 in direction 72, lens barrel 50 retracts from the extended position and extension 30 disengages sensor 144, thereby causing sensor 144 to interrupt and/or cease transmitting a signal to printed circuit board 140 and/or otherwise causing printed circuit board 40 to cause light 130 to be turned “off.” It should be understood that other types of electrical communications and/or devices may be used to switch light 130 “on” and “off” based on a position of lens assembly 110 (e.g., electrical contacts and/or switches disposed on lens assembly 110 and various corresponding location(s) within housing 102).

Thus, embodiments of projection device 100 are configured to enable projection device 100 to be compact in nature. For example, when projection device 100 is in an “off” mode of operation, lens assembly 110 (and corresponding lens barrel 50) are located in a retracted position, thereby decreasing an overall length of projection device. Actuation and/or movement of lens assembly 110 relative to housing 102 causes projection device 100 to be automatically turned “on” while also locating lens assembly 110 at a particular location within housing 102 relative to lens assembly 120 to obtain the desired separation and/or spacing between lens assemblies 110 and 120 to produce the desired output image 45.

What is claimed is:

1. A projection device, comprising:
a first lens assembly movably disposed within a housing and configured to automatically activate the projection device to display an image in response to the first lens assembly being moved to an extended position relative to a second lens assembly.

2. The projection device of claim 1, wherein the first lens assembly is configured to cause deactivation of the projection device in response to the first lens assembly being moved from the extended position to a retracted position relative to the second lens assembly.

3. The projection device of claim 1, wherein the first lens assembly comprises a lens barrel extendable relative to an opening in the housing when the first lens assembly is moved to the extended position.

4. The projection device of claim 1, wherein the first lens assembly comprises a lens barrel retractable relative to an opening in the housing when the first lens assembly is moved from the extended position to a retracted position.

5. The projection device of claim 1, further comprising a slider accessible from an exterior of the housing and coupled to the first lens assembly for causing movement of the first lens assembly relative to the housing.

6. The projection device of claim 1, further comprising a sensor configured to detect a position of the first lens assembly within the housing.

7. The projection device of claim 1, further comprising a sensor configured to cause activation of a light within the housing in response to the first lens assembly being moved to the extended position.

8. The projection device of claim 1, further comprising a sensor configured to cause deactivation of a light within the housing in response to the first lens assembly being moved from the extended position to a retracted position.

9. A projection device, comprising:
means for moving a first lens means disposed within a housing means relative to a second lens means disposed within the housing means; and
means for automatically activating the projection device to display an image in response to the first lens means being moved to an extended position relative to the second lens means.

10. The projection device of claim 9, further comprising means for detecting a position of the first lens means within the housing means.

11. The projection device of claim 9, further comprising means for activating a light means in response to the first lens means being moved to the extended position.

12. The projection device of claim 9, further comprising means for deactivating a light means in response to the first lens means being moved from the extended position to a retracted position.

13. The projection device of claim 9, further comprising means for extending at least a portion of the first lens means through the housing means when the first lens means is moved to the extended position.

14. A projection device, comprising:
a first lens assembly disposed at least partially within a housing and movable from a first position to a second position in the housing, wherein the second position places the first lens assembly a predetermined distance from a second lens assembly disposed within the housing to enable projection of an image using the first and second lens assemblies.

15. The projection device of claim 14, wherein the first lens assembly comprises a lens barrel extendable relative to the housing.

16. The projection device of claim 14, wherein the first lens assembly comprises a lens barrel movable from a retracted position to an extended position relative to the housing in response to the first lens assembly being moved from the first position to the second position.

17. The projection device of claim 14, further comprising a sensor configured to detect a position of the first lens assembly within the housing.

18. The projection device of claim 14, further comprising a sensor configured to cause activation of a light within the housing in response to the first lens assembly being moved to the second position.

19. The projection device of claim 14, further comprising a sensor configured to cause deactivation of a light within the housing in response to the first lens assembly being moved from the second position to the first position.

20. The projection device of claim 14, further comprising a slider accessible from an exterior of the housing and coupled to the first lens assembly for causing movement of the first lens assembly relative to the housing.
